(19) United States
(12) Patent Application Publication
(10) Pub. No.: US 2025/0266425 A1
(43) Pub. Date: Aug. 21, 2025

(54) COMPOSITE ANODE LAYER INCLUDING A BINDER FOR ALL-SOLID-STATE BATTERY WITH EXCELLENT ADHESION PROPERTIES, ALL-SOLID-STATE BATTERY INCLUDING SAME, AND METHOD OF MANUFACTURING COMPOSITE ANODE INCLUDING THE COMPOSITE ANODE LAYER

(71) Applicants: Hyundai Motor Company, Seoul (KR); Kia Corporation, Seoul (KR); Industry-University Cooperation Foundation Hanyang University, Seoul (KR)

(72) Inventors: Ga Hyeon Im, Hwaseong (KR); Yoon Kwang Lee, Suwon (KR); Kyu Joon Lee, Seoul (KR); So Young Lee, Suwon (KR); Yun Sung Kim, Seoul (KR); Jong Han Jun, Seoul (KR); Dong Won Kim, Seoul (KR); Young Jun Lee, Seoul (KR); Han Jo Lee, Seoul (KR); Yong Han Jo, Seoul (KR)

(21) Appl. No.: 18/794,244

(22) Filed: Aug. 5, 2024

(30) Foreign Application Priority Data
Feb. 16, 2024 (KR) 10-2024-0022371

(51) Int. Cl. H01M 4/133; H01M 4/02; H01M 4/587; H01M 4/62; H01M 10/0562

(52) U.S. Cl. CPC H01M 4/133; H01M 4/587; H01M 4/622; H01M 10/0562; H01M 2004/027; H01M 2220/20; H01M 2300/008

(57) ABSTRACT

A composite anode layer including a binder for an all-solid-state battery with excellent adhesion properties, an all-solid-state battery including the same, and a method of manufacturing a composite anode including the composite anode layer, in which a binder that is soluble in a nonpolar or low polarity solvent can be employed in an anode layer, thus making it possible to manufacture a composite anode for an all-solid-state battery that exhibits high adhesion properties even when the amount of the binder is low and has improved lifespan characteristics.

### CROSS-REFERENCE TO RELATED APPLICATION

This application claims, under 35 U.S.C. § 119(a), the benefit of priority from Korean Patent Application No. 10-2024-0022371, filed on Feb. 16, 2024, the entire contents of which are incorporated herein by reference.

### BACKGROUND

### (a) Technical Field

The present disclosure relates to a composite anode layer including a binder for an all-solid-state battery with excellent adhesion properties. It also covers an all-solid-state battery including this composite anode layer, and a method of manufacturing it. By using a binder soluble in a nonpolar or low polarity solvent, the composite anode can be produced with high adhesion properties even with a low binder content, leading to improved lifespan characteristics.

### (b) Background Art

Lithium-ion batteries are widely used in various energy storage devices. Depending on application, different battery characteristics are required, such as high energy density, long cycle life, fast charging and discharging, high/low-temperature performance.

Recently, in order to solve environmental problems caused by carbon dioxide (CO₂), the use of fossil fuel has been avoided, so the industry of automobiles, which are a means of transportation, is showing great interest in electric vehicles that use secondary batteries. Currently developed lithium-ion batteries are able to travel about 400 km on a single charge, but problems such as instability at high temperatures, fire, etc. still occur. With the goal of solving these problems, many companies are competitively developing next-generation secondary batteries.

All-solid-state batteries, gaining attention as next-generation secondary batteries, have all components made of solids. This design reduces the risk of fire and explosion and provides higher mechanical strength compared to the lithium-ion batteries, which use flammable organic solvents as electrolytes. The all-solid-state battery generally includes a cathode layer attached to a cathode current collector, an anode layer attached to an anode current collector, and a solid electrolyte layer disposed between the cathode layer and the anode layer.

The anode layer is used as a composite anode layer by mixing an anode active material such as graphite, silicon, etc. with a solid electrolyte for lithium ion (Li⁺) conduction. It includes a binder that enhances interfacial contact between the solid electrolyte and the anode active material, providing excellent electrical and mechanical properties.

A sulfide-based solid electrolyte, which is mainly used as a solid electrolyte included in the anode layer, may react with a highly polar solvent, destroying crystallinity and lowering ionic conductivity. In order to avoid this problem, a nonpolar or low polarity solvent is used in the process of manufacturing the composite anode layer. Accordingly, the binder included in the composite anode layer must also be one that is easily soluble in a nonpolar or low polarity solvent.

### SUMMARY

Nitrile-butadiene rubber (NBR) containing a nitrile functional group is widely known as a binder included in a composite anode layer including an anode active material and a solid electrolyte. Rubber-based binders such as nitrile butadiene rubber are not sufficiently dissolved in nonpolar or low polarity solvents, and thus have a problem of showing low binding and adhesion properties. Accordingly, composite anode layers manufactured using existing rubber-based binders have many difficulties in attaining a stable cycle life due to insufficient binding strength between electrode components and insufficient adhesion to the current collector during charging and discharging.

In an aspect, the present disclosure has been made keeping in mind such problems and is intended to provide a binder that exhibits high solubility in nonpolar or low polarity solvents instead of a rubber-based binder as a binder included in a composite anode layer.

Accordingly, in an aspect, an object of the present disclosure is to provide an all-solid-state battery that exhibits high binding and adhesion properties even when the amount of the binder is relatively low and thus has improved output characteristics and lifespan characteristics. Furthermore, the composite anode layer is imparted with mechanical and electrical properties such as flexibility, adhesion, resistance, and the like by adjusting the amount of vinyl acetate in the binder.

The objects of the present disclosure are not limited to the foregoing. The objects of the present disclosure will be able to be clearly understood through the following description and to be realized by the means described in the claims and combination thereof.

An aspect of the present disclosure provides a composite anode layer, including an anode active material, a solid electrolyte having lithium ion conductivity, and a binder capable of binding the anode active material and the solid electrolyte together, in which the binder may include an ethylene-vinyl acetate copolymer.

In an embodiment, the anode active material may be capable of intercalation and deintercalation of lithium ions. Preferably, the anode active material may be capable of intercalation and deintercalation of lithium ions to the extent sufficient to provide a functional all-solid-state battery In preferred aspects, the anode active material may be capable of intercalation and deintercalation of lithium ions which may include any one selected from the group consisting of a graphite-based active material, a silicon-based active material, lithium titanium oxide, and combination thereof.

The graphite-based active material may include any one selected from the group consisting of natural graphite, artificial graphite, and combination thereof.

The silicon-based active material may include any one selected from the group consisting of silicon, silicon oxide, silicon carbide, a silicon alloy, and combination thereof.

The lithium titanium oxide may include any one selected from the group consisting of Li₄Ti₅O₁₂, LiTi₂O₄, Li₂TiO₃, Li₂Ti₃O₇, and combination thereof.

In an embodiment, the solid electrolyte may include a sulfide-based or an oxide-based solid electrolyte. For example, the sulfide-based solid electrolyte may include any one selected from the group consisting of Li₆PS₅X (X═Cl, Br, or I), Li₁₀GeP₂S₁₂, Li₃PS₄, Li₇P₃S₁₁, and combination thereof.

In an embodiment, the binder may be evenly dispersed in the composite anode layer without forming a separate layer.

In an embodiment, the ethylene-vinyl acetate copolymer may be represented by Chemical Formula 1 below.

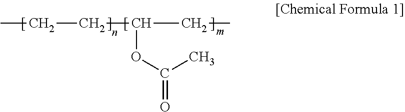

(in which n and m are integers of 1 or more)

In an embodiment, the ethylene-vinyl acetate copolymer may include about 10 wt % to 90 wt % of vinyl acetate.

Preferably, the ethylene-vinyl acetate copolymer includes about 40 wt % to 70 wt % of vinyl acetate.

More preferably, the ethylene-vinyl acetate copolymer includes about 55 wt % to 65 wt % of vinyl acetate.

In an embodiment, the composite anode layer may include, based on a total weight of the composite anode layer, about 60 wt % to 90 wt % of the anode active material, about 10 wt % to 45 wt % of the solid electrolyte, and about 0.1 wt % to 5 wt % of the binder.

Another aspect of the present disclosure provides an all-solid-state battery, including an anode current collector, the composite anode layer disposed on the anode current collector, a solid electrolyte layer disposed on the composite anode layer and including a solid electrolyte, a cathode layer disposed on the solid electrolyte layer and including a cathode active material, and a cathode current collector disposed on the cathode layer.

The cathode active material may include an oxide active material or a sulfide active material.

Still another aspect of the present disclosure provides a method of manufacturing a composite anode, including preparing a composite anode slurry by adding an anode active material, a solid electrolyte, and a binder to an organic solvent and performing mixing, and forming a composite anode layer by applying the composite anode slurry onto an anode current collector and performing drying. The binder includes an ethylene-vinyl acetate copolymer.

In an embodiment, the organic solvent may include any one selected from the group consisting of N-butyl butyrate, benzyl acetate, 1,4-dichlorobutane, dichlorobenzene, and combination thereof.

In a further aspect, vehicles are provided that comprise a vehicle as disclosed herein, including an all-solid-state battery.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows an all-solid-state battery including a composite anode layer according to the present disclosure;

FIG. 2 shows a composite anode layer according to the present disclosure;

FIG. 3 shows results of differential scanning calorimetry (DSC) of Examples;

FIG. 4 shows results of XRD (X-ray diffraction) analysis on various compositions used in a process of manufacturing Examples;

FIG. 5 shows a process of evaluation of peel strength of a composite anode layer;

FIG. 6 shows results of measurement of peel strength of composite anode layers including 2 wt % of a binder;

FIG. 7 shows results of measurement of peel strength of composite anode layers including 1 wt % of a binder;

FIG. 8 shows results of DC-IR evaluation of the composite anode layers including 2 wt % of the binder;

FIG. 9 shows results of DC-IR evaluation of the composite anode layers including 1 wt % of the binder;

FIG. 10 shows results of measurement of direct-current resistance of the composite anode layers including 2 wt % of the binder;

FIG. 11 shows results of measurement of direct-current resistance of the composite anode layers including 1 wt % of the binder;

FIG. 12 shows results of measurement of discharge capacity depending on the cycle number of the composite anode layers including 2 wt % of the binder; and

FIG. 13 shows results of measurement of discharge capacity depending on the cycle number of the composite anode layers including 1 wt % of the binder.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combination of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combination thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

### Composite Anode Layer

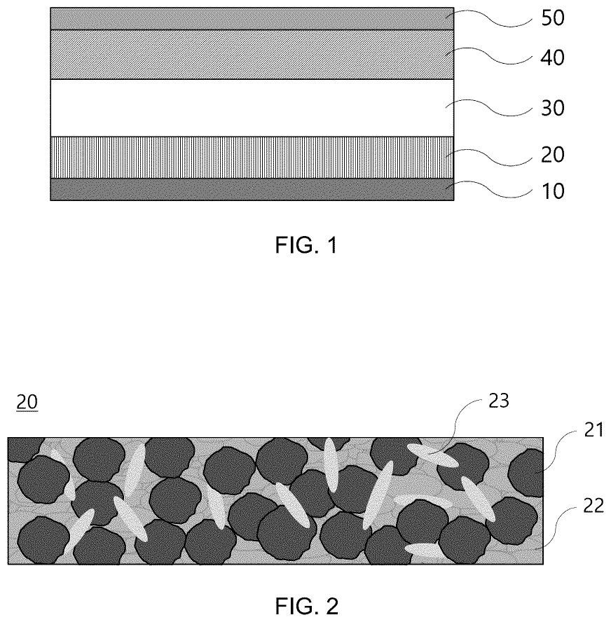

FIG. 1 shows an all-solid-state battery including a composite anode layer 20 according to the present disclosure. The composite anode layer 20 according to the present disclosure may be interposed between an anode current collector 10 and a solid electrolyte layer 30.

FIG. 2 shows the composite anode layer 20 according to the present disclosure. As shown in FIG. 2, the composite anode layer 20 may include an anode active material 21 capable of intercalation and deintercalation of lithium ions, a solid electrolyte 22 having lithium ion conductivity, and a binder 23 allowing the anode active material 21 and the solid electrolyte 22 to bind each other, and the binder 23 may include an ethylene-vinyl acetate copolymer.

The anode active material 21 may be a compound capable of reversible intercalation and deintercalation of lithium. For example, the anode active material 21 may include any one selected from the group consisting of a graphite-based active material, a silicon-based active material, lithium titanium oxide, and combination thereof.

Here, the graphite-based active material may include any one selected from the group consisting of natural graphite, artificial graphite, and combination thereof. The silicon-based active material may include any one selected from the group consisting of silicon (Si), silicon oxide (SiOₓ; 0<x≤2), silicon carbide (SiCₓ; 0<x≤1), a silicon alloy, and combination thereof. The lithium titanium oxide (LTO) may include any one selected from the group consisting of Li₄Ti₅O₁₂, LiTi₂O₄, Li₂TiO₃, Li₂Ti₃O₇, and combination thereof.

Also, according to the present disclosure, the composite anode layer 20 may include a solid electrolyte 22 with high ionic conductivity, thereby improving the mobility of lithium ions in the composite anode layer 20 during charging and discharging. The solid electrolyte 22 may include an oxide-based solid electrolyte, a sulfide-based solid electrolyte, etc., and preferably, the solid electrolyte 22 includes a sulfide-based solid electrolyte.

The sulfide-based solid electrolyte is not particularly limited and examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S-SiS2-P₂S₅—LiI, Li₂S—B₂S₃, Li₂S—P₂S₅-ZmSn (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂Si₂, and the like. Also, the sulfide-based solid electrolyte may include one having an argyrodite-type crystal structure.

Preferably, the sulfide-based solid electrolyte includes any one selected from the group consisting of Li₆PS₅X (X═Cl, Br, or I), Li₁₀GeP₂Si₂, Li₃PS₄, Li₇P₃S₁₁, and combination thereof.

Referring to FIG. 2, the anode active material 21 and the solid electrolyte 22 may be represented such that the solid electrolyte fills the space between particles of the anode active material 21 in the composite anode layer 20, depending on their relative amounts, Alternatively, the particles of the anode active material 21 can be dispersed in the solid electrolyte 22.

Since the anode active material 21 and the solid electrolyte 22 of the composite anode layer 20 are both solids, contact and binding strength between components in the composite anode layer 20 may be low. Likewise, since all components of individual layers of an all-solid-state battery are also solids, interfacial resistance may be lowered only when sufficient adhesion and contact are ensured between the composite anode layer 20 and the anode current collector 10 and between the composite anode layer 20 and the solid electrolyte layer 30.

Accordingly, the composite anode layer 20 according to the present disclosure may include a binder 23. Here, the binder 23 is easily soluble in a nonpolar or low polarity solvent, and an ethylene-vinyl acetate copolymer, rather than a conventional rubber-based binder, may be used. The ethylene-vinyl acetate copolymer may have an acetate functional group at the side chain and may be a copolymer of vinyl acetate monomer and ethylene monomer.

Conventional rubber-based binders are not easily soluble in nonpolar or low polarity solvents, requiring a high amount to provide sufficient binding strength. This results in a lower energy density of the composite anode layer 20. According to the present disclosure, an ethylene-vinyl acetate copolymer that is easily soluble in nonpolar or low polarity solvents is used as the binder 23. This allows for high binding and adhesion properties even when with a low amount of binder. Ultimately, an all-solid-state battery with improved output characteristics and lifespan characteristics may be obtained.

For example, the ethylene-vinyl acetate copolymer may be represented by Chemical Formula 1 below.

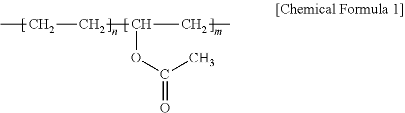

(in which n and m are integers of 1 or more)

Referring to Chemical Formula 1, the ethylene-vinyl acetate copolymer may include an alternating copolymer, a block copolymer, etc., depending on the integers n and m.

Also, according to the present disclosure, it is possible to control the mechanical and electrical properties of the composite anode layer 20 such as flexibility, adhesion, and resistance by adjusting the amount of vinyl acetate contained in the ethylene-vinyl acetate copolymer.

In an embodiment, the ethylene-vinyl acetate copolymer may include 10 wt % to 90 wt % of vinyl acetate. Preferably, the ethylene-vinyl acetate copolymer includes 40 wt % to 70 wt % of vinyl acetate. More preferably, the ethylene-vinyl acetate copolymer includes 55 wt % to 65 wt % of vinyl acetate.

If the amount of vinyl acetate in the ethylene-vinyl acetate copolymer is less than 10 wt %, the thermal stability of the binder 23 may decrease. This is because polyethylene, contained in the ethylene-vinyl acetate copolymer, has a lower glass transition temperature (T_{g}) than (poly)vinyl acetate. On the other hand, if the amount of vinyl acetate in the ethylene-vinyl acetate copolymer exceeds 90 wt %, the glass transition temperature (T_{g}) may increase above room temperature, making it difficult to provide flexibility to the electrode.

In addition, when the ethylene-vinyl acetate copolymer includes 40 wt % to 70 wt % of vinyl acetate, the composite anode layer 20 may exhibit superior mechanical and electrical properties such as flexibility, adhesion, and resistance. When the ethylene-vinyl acetate copolymer includes 55 wt % to 65 wt % of vinyl acetate, the composite anode layer 20 may exhibit vastly superior mechanical and electrical properties in these areas.

The binder 23 may be evenly dispersed in the composite anode layer 20 without forming a separate layer therein. In this way, when the binder 23 according to the present disclosure is evenly dispersed in the composite anode layer 20 without forming a separate layer, binding strength between the anode active material 21 and the solid electrolyte 22 may be improved. Also, binding and adhesion properties between the composite anode layer 20 and the anode current collector 10 or between the composite anode layer 20 and the solid electrolyte layer 30 may be improved.

As will be described later in “Method of manufacturing composite anode,” the composite anode layer 20 is derived from a composite anode slurry. This slurry is prepared by adding an anode active material 21, a solid electrolyte 22, and a binder 23 to an organic solvent and then performing mixing, a binder layer that exists separately from the anode active material 21 and the solid electrolyte 22 is not formed. Moreover, the binder 23 may not be provided as a separate coating layer covering the surface or outer surface of the anode active material 21.

In cases in which the binder 23 forms a separate binder layer or is provided in the form of a coating layer on the surface of the anode active material 21, it may be difficult to effectively improve binding and adhesion properties between the composite anode layer 20 and the anode current collector 10 or between the composite anode layer 20 and the solid electrolyte layer 30.

In an embodiment, the composite anode layer 20 may include, based on the total weight thereof, 60 wt % to 90 wt % of the anode active material 21, 10 wt % to 45 wt % of the solid electrolyte 22, and 0.1 wt % to 5 wt % of the binder 23.

The composite anode layer 20 according to the present disclosure may include the binder 23 in an amount as low as 0.1 wt % to 5 wt %, whereby the relative amounts of the anode active material 21 and the solid electrolyte 22 may be increased. Accordingly, high binding and adhesion properties may be exhibited even when the amount of the binder is low, improving output characteristics and lifespan characteristics of the all-solid-state battery.

If the amount of the binder 23 is less than 0.1 wt %, it may be difficult for the binder 23 to exhibit sufficient binding and adhesion properties, whereas if the amount of the binder 23 exceeds 5 wt %, the relative amounts of the anode active material 21 and the solid electrolyte 22 in the composite anode layer 20 may decrease, lowering the energy density of the all-solid-state battery.

In an embodiment, peel strength between the anode current collector and the composite anode layer may be 2 gf/mm or more. If peel strength between the anode current collector and the composite anode layer is less than 2 gf/mm, it may be difficult to exhibit sufficient binding and adhesion properties between the anode current collector and the composite anode layer.

In an embodiment, peel strength between the anode current collector and the composite anode layer may be 3 gf/mm or more. Preferably, the amount of the binder in the composite anode layer is 1 wt % or less and simultaneously peel strength between the anode current collector and the composite anode layer is 3 gf/mm or more. It is generally known that peel strength increases with an increase in the amount of the binder in the composite anode layer. According to the present disclosure, a peel strength of 3 gf/mm or more may be achieved even when the binder is used in a low amount of 1 wt % or less.

In an embodiment, peel strength between the anode current collector and the composite anode layer may be 15 gf/mm or more. Preferably, the amount of the binder in the composite anode layer is 2 wt % or less and simultaneously peel strength between the anode current collector and the composite anode layer is 15 gf/mm or more. According to the present disclosure, peel strength of 15 gf/mm or more may be provided even when the binder is used in a low amount of 2 wt % or less.

The upper limit of peel strength between the anode current collector and the composite anode layer is not particularly limited and may be, for example, 1000 gf/mm or less, or 500 gf/mm or less, as long as the amount of the binder in the composite anode layer does not exceed 5 wt %.

Here, peel strength may be evaluated by a method commonly used in the relevant technical field to evaluate adhesion between the anode current collector and the anode layer. As a non-limiting example, peel strength may be measured using a universal testing machine. As such, a peel speed for measuring peel strength may be appropriately adjusted depending on the amount of the binder in the composite anode layer.

If the amount of the anode active material 21 is less than 60 wt %, energy density of the all-solid-state battery may decrease, whereas if the amount of the anode active material 21 exceeds 90 wt %, the relative amount of the solid electrolyte 22 or the binder 23 may be excessively low. Also, if the amount of the solid electrolyte 22 is less than 10 wt %, lithium ion conductivity of the composite anode layer 20 may decrease, deteriorating battery performance. On the other hand, if the amount of the solid electrolyte 22 exceeds 45 wt %, the relative amounts of the anode active material 21 and the binder 23 may be excessively low.

Referring again to FIG. 1, the all-solid-state battery including the composite anode layer 20 according to the present disclosure may include an anode current collector 10, the composite anode layer 20 disposed on the anode current collector 10, a solid electrolyte layer 30 disposed on the composite anode layer 20 and including a solid electrolyte, a cathode layer 40 disposed on the solid electrolyte layer 30 and including a cathode active material, and a cathode current collector 50 disposed on the cathode layer 40.

The anode current collector 10 may be a plate-type substrate having electrical conductivity. Specifically, the anode current collector 10 may be in the form of a sheet, thin film, or foil.

The anode current collector 10 may include a material that does not react with lithium. Specifically, the anode current collector 10 may include at least one selected from the group consisting of nickel (Ni), copper (Cu), stainless steel, and combination thereof.

The thickness of the anode current collector 10 is not particularly limited and may be, for example, 1 m to 500 km.

The solid electrolyte layer 30 may be disposed between the cathode layer 40 and the composite anode layer 20 and may include a solid electrolyte having lithium ion conductivity.

The solid electrolyte may include any one selected from the group consisting of an oxide-based solid electrolyte, a sulfide-based solid electrolyte, a polymer electrolyte, and combination thereof. Here, it is preferable to use a sulfide-based solid electrolyte having high lithium ion conductivity.

The sulfide-based solid electrolyte is not particularly limited and examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S-SiS2-P₂S₅—LiI, Li₂S—B₂S₃, Li₂S—P₂S₅-ZmSn (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like. Preferably, the sulfide-based solid electrolyte includes any one selected from the group consisting of Li₆PS₅X (X═Cl, Br, or I), Li₁₀GeP₂S₁₂, Li₃PS₄, Li₇P₃S₁₁, and combination thereof.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the polymer electrolyte may include a gel polymer electrolyte, a solid polymer electrolyte, and the like.

The solid electrolyte included in the solid electrolyte layer 30 may be the same as or different from the solid electrolyte 22 included in the composite anode layer 20.

The solid electrolyte layer 30 may further include a binder. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), an ethylene-vinyl acetate copolymer, and the like.

When a sulfide-based solid electrolyte is used in the solid electrolyte layer 30, an ethylene-vinyl acetate copolymer may be used as the binder. Here, the ethylene-vinyl acetate copolymer may be substantially the same as that included in the composite anode layer 20.

The cathode layer 40 is configured to reversibly store and release lithium ions, and may include a cathode active material, a conductive material, and a binder. Additionally, some of the solid electrolyte may be mixed.

The cathode active material may be an oxide active material or a sulfide active material.

Examples of the oxide active material may include a rocksalt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-including active material such as Li₂FeSiO₄, Li₂MnSiO₄, etc., a rocksalt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like.

Examples of the sulfide active material may include copper Chevrel, iron sulfide, cobalt sulfide, nickel sulfide, and the like.

The solid electrolyte mixed in the cathode layer 40 may be substantially the same as the solid electrolyte included in the solid electrolyte layer 30.

Examples of the conductive material may include carbon black, conductive graphite, ethylene black, carbon fiber, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector 50 may be a plate-type substrate having electrical conductivity. Specifically, the cathode current collector 50 may be in the form of a sheet or a thin film. The cathode current collector 50 may include at least one material selected from the group consisting of indium (In), copper (Cu), magnesium (Mg), aluminum (Al), stainless steel, iron, and combination thereof. Specifically, the cathode current collector 50 may include an aluminum foil.

The thickness of the cathode current collector 50 is not particularly limited and may be, for example, 1 μm to 500 μm.

Below is a description of a method of manufacturing a composite anode including the composite anode layer 20 according to the present disclosure.

### Method of Manufacturing Composite Anode

The method of manufacturing a composite anode according to the present disclosure may include preparing a composite anode slurry by adding an anode active material 21, a solid electrolyte 22, and a binder 23 to an organic solvent and performing mixing, and forming a composite anode layer 20 by applying the composite anode slurry onto an anode current collector 10 and performing drying.

Individual steps thereof are described below.

The organic solvent may be one that prevents destruction of crystallinity of the solid electrolyte 22 or lowering of ionic conductivity due to chemical reaction with the solid electrolyte 22. In particular, an organic solvent that does not chemically react with the sulfide-based solid electrolyte 22 may be used.

The organic solvent may be nonpolar or may have low polarity. For example, the organic solvent may include any one selected from the group consisting of N-butyl butyrate, benzyl acetate, 1,4-dichlorobutane, dichlorobenzene, and combination thereof.

The amount of solvent used should be sufficient to dissolve or disperse the anode active material 21, the solid electrolyte 22, and the binder 23. This consideration takes into account the coating thickness of the composite anode slurry and the preparation yield and the need to achieve a viscosity that ensures excellent thickness uniformity during coating for subsequent composite anode formation.

The anode active material 21, the solid electrolyte 22, and the binder 23 described in “Composite anode layer” above may be added to the organic solvent. Here, the anode active material 21 may include any one selected from the group consisting of a graphite-based active material, a silicon-based active material, lithium titanium oxide, and combination thereof, the solid electrolyte 22 may be a sulfide-based solid electrolyte, and the binder 23 may be an ethylene-vinyl acetate copolymer. A detailed description thereof is substantially the same as those described above and thus will be omitted.

The anode active material 21, the solid electrolyte 22, and the binder 23 may be added to the organic solvent so as to satisfy 60 wt % to 90 wt % of the anode active material 21, 10 wt % to 45 wt % of the solid electrolyte 22, and 0.1 wt % to 5 wt % of the binder 23.

Thereafter, a composite anode slurry may be prepared by mixing the anode active material 21, the solid electrolyte 22, and the binder 23 with the organic solvent. Any mixing method may be performed without particular limitation, so long as it is a mixing method commonly used in the art. For example, stirring, etc. may be performed.

The composite anode slurry thus prepared may be applied onto the anode current collector 10. The amount of the composite anode slurry that is applied may be appropriately adjusted depending on the desired performance or capacity of the all-solid-state battery.

Thereafter, a composite anode including the anode current collector 10 and the composite anode layer 20 may be manufactured by vacuum drying the composite anode slurry applied onto the anode current collector 10. The vacuum drying time and temperature should be sufficient to evaporate or remove the solvent from the composite anode slurry. Typical drying temperature and time used in the relevant technical field may be applied.

Meanwhile, since the anode current collector 10 has substantially the same configuration as that described in “Composite anode layer,” a redundant description thereof will be omitted.

A better understanding of the present disclosure may be obtained through the following examples and comparative example. However, these examples are not to be construed as limiting the technical spirit of the present disclosure.

### Example 1—EVA40

A Si—C composite, an argyrodite-type sulfide-based solid electrolyte (Li₆PS₅X, X═Cl or Br), and an ethylene-vinyl acetate copolymer (EVA40) having 40 wt % of vinyl acetate were prepared as an anode active material, a solid electrolyte, and a binder, respectively.

A composite anode slurry was prepared by dispersing the anode active material, the solid electrolyte, and the binder in n-butyl butyrate. Here, the amount of the binder was 2 wt % or 1 wt % based on the total weight of the anode active material, the solid electrolyte, and the binder.

A composite anode with a composite anode layer disposed on an anode current collector was manufactured by applying the composite anode slurry onto a nickel current collector and vacuum drying the same. Here, the loading level of the anode active material in the composite anode layer was about 3.3 mg/cm².

### Example 2—EVA50

A composite anode was manufactured in the same manner as in Example 1, with the exception that an ethylene-vinyl acetate copolymer (EVA50) having 50 wt % of vinyl acetate was used as a binder.

### Example 3—EVA60

A composite anode was manufactured in the same manner as in Example 1, with the exception that an ethylene-vinyl acetate copolymer (EVA60) having 60 wt % of vinyl acetate was used as a binder.

### Example 4—EVA70

A composite anode was manufactured in the same manner as in Example 1, with the exception that an ethylene-vinyl acetate copolymer (EVA70) having 70 wt % of vinyl acetate was used as a binder.

### Comparative Example 1—NBR

A Si—C composite, an argyrodite-type sulfide-based solid electrolyte (Li₆PS₅X, X═Cl or Br), and nitrile-butadiene rubber (NBR) having 25 wt % of acrylonitrile and 75 wt % of butadiene were prepared as an anode active material, a solid electrolyte, and a binder, respectively.

A composite anode slurry was prepared by dispersing the anode active material, the solid electrolyte, and the binder in n-butyl butyrate. Here, the amount of NBR as the binder was 2 wt % or 1 wt % based on the total weight of the anode active material, the solid electrolyte, and the binder.

A composite anode with a composite anode layer disposed on an anode current collector was manufactured by applying the composite anode slurry onto a nickel current collector and vacuum drying the same. Here, the loading level of the anode active material in the composite anode layer was about 3.3 mg/cm².

### Test Example 1—Evaluation of Thermal Properties of Binder

Differential scanning calorimetry (DSC) was performed to confirm thermal properties of the polymer depending on the amount of vinyl acetate in the EVA binder used to manufacture the composite anode in Examples.

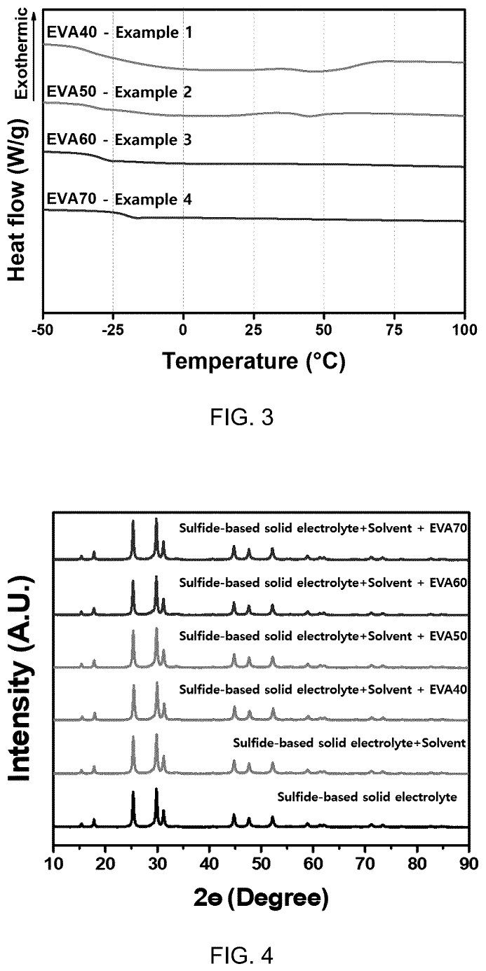

DSC was performed at a heating rate of 5° C./min, and the results, shown in FIG. 3, confirm that the glass transition temperature (T_{g}) of the polymer increased with an increase in the amount of vinyl acetate. This is likely because poly(vinyl acetate) has a higher glass transition temperature than polyethylene included in the EVA copolymer.

### Test Example 2—Evaluation of Chemical Stability of Composite Anode Layer Including Binder

XRD analysis was performed to evaluate stability of a sulfide-based solid electrolyte for the EVA binder and the organic solvent (n-butyl butyrate) used to manufacture the composite anode in Examples 1 to 4, and the results thereof are shown in FIG. 4.

Specifically, a sulfide-based solid electrolyte was added to an n-butyl butyrate solvent and mixed for 48 hours to obtain a mixture, and a sulfide-based solid electrolyte was added to individual n-butyl butyrate solutions in which EVA introduced in various amounts in Examples 1 to 4 was dissolved and mixed for 48 hours to obtain mixtures. Each mixture was dried in a vacuum oven to remove the solvent therefrom and then XRD analysis was performed. Here, the results of XRD of the sulfide-based solid electrolyte, used to confirm whether the structural stability of the solid electrolyte is maintained, are also shown in FIG. 4.

Referring to FIG. 4, it was confirmed that the structural stability of the sulfide-based solid electrolyte was well maintained in all compositions of Examples.

### Test Example 3—Evaluation of Adhesion of Composite Anode

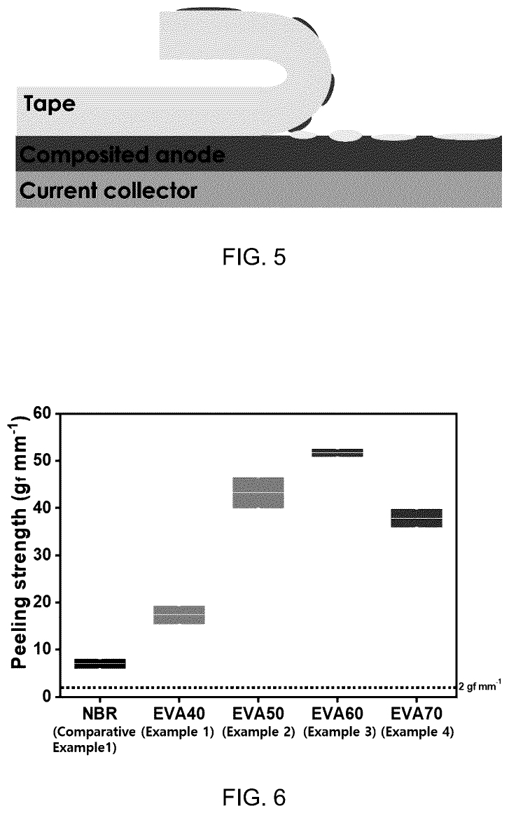

In order to evaluate adhesion of the composite anodes manufactured using EVA in Examples 1 to 4 and the composite anode manufactured using NBR in Comparative Example 1, peel strength was measured in a manner as shown in FIG. 5 using a universal testing machine.

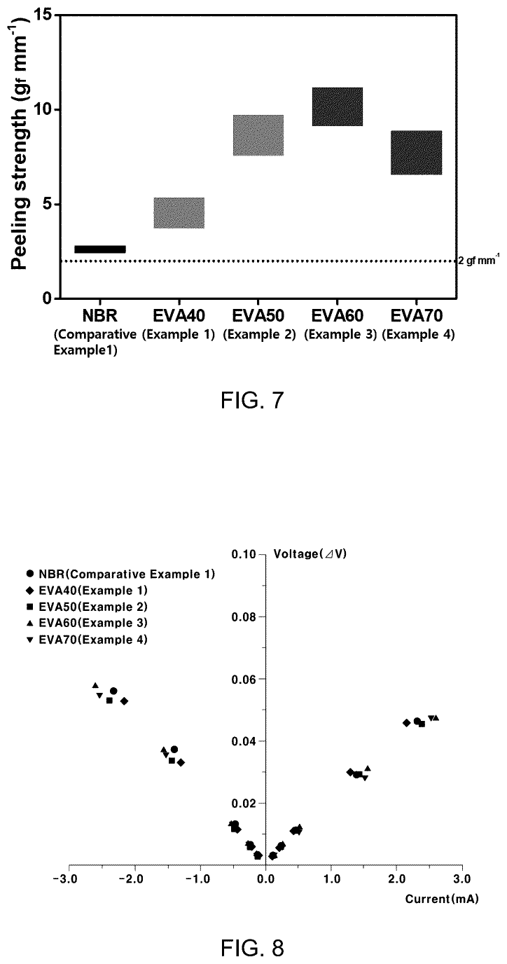

Here, the amount of the binder used in the composite anodes was 1.0 wt % or 2.0 wt %. Evaluation was conducted at a speed of 150 mm/min for the composite anodes including 2.0 wt % of the binder, and at a speed of 30 mm/min for the composite anodes including 1.0 wt % of the binder. The results of measurement of peel strength of the composite anodes of Examples 1 to 4 and Comparative Example 1 are shown in FIG. 6 (2 wt % of binder) and FIG. 7 (1 wt % of binder).

Referring to FIGS. 6 and 7, the adhesion of the composite anodes manufactured using the EVA binder was greater than that of the composite anode manufactured using NBR, regardless of the amount of the binder. Among the Examples using the EVA binder, the composite anode of Example 3, including EVA60 as the binder, showed the best peel strength.

The reason why peel strength was lower in EVA70 (Example 4) in which the amount of vinyl acetate was high than in EVA60 is deemed to be because the flexibility of the electrode was reduced by EVA70 having a high glass transition temperature (T_{g}).

### Test Example 4—Evaluation of Internal Resistance of Composite Anode

The internal resistance of the composite anodes manufactured in Examples 1 to 4 and Comparative Example 1 was measured. Here, internal resistance was measured using DC-IR in a manner of calculating resistance by applying a constant direct current and then measuring the voltage change.

For DC-IR measurement, an all-solid-state battery for composite anode evaluation was manufactured as follows. 150 mg of a sulfide-based solid electrolyte was placed in a poly(ether ether ketone) (PEEK) mold and then pressed at room temperature under a pressure of 110 MPa to form a solid electrolyte pellet, on which the manufactured composite anode (Examples and Comparative Example) was then placed, followed by pressing at a pressure of 450 MPa.

Lithium metal was then placed on the opposite side of the solid electrolyte pellet, and a cell was manufactured at a clamping pressure of 60 MPa.

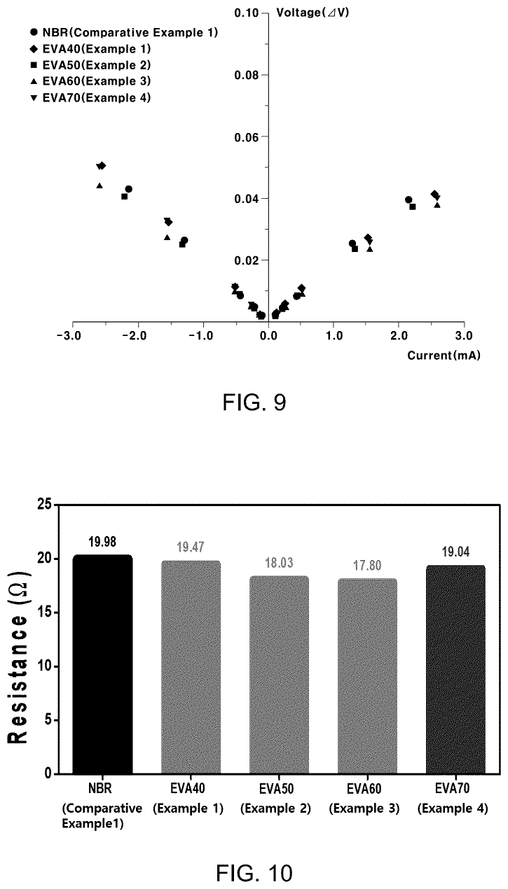

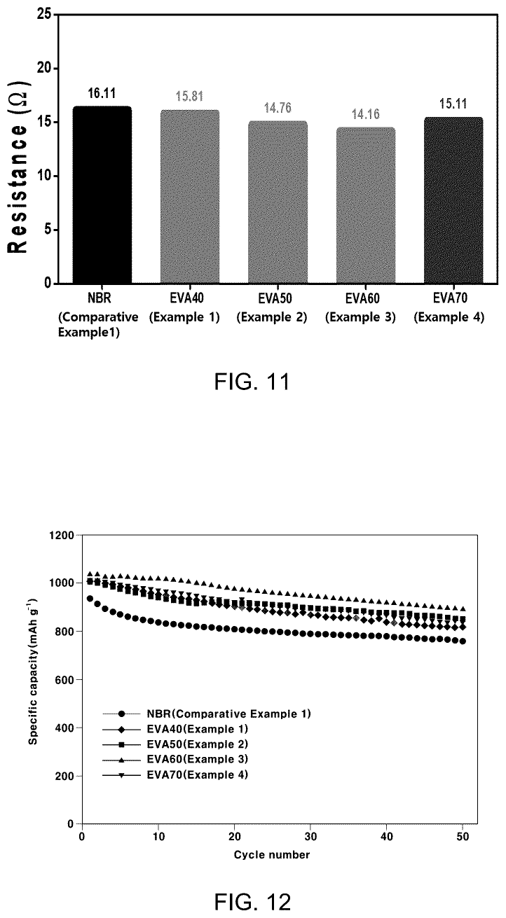

FIGS. 8 and 9 show results of DC-IR measurement of the composite anodes of Examples 1 to 4 and Comparative Example 1 when using 2.0 wt % of the binder and 1.0 wt % of the binder, respectively, and FIGS. 10 and 11 show results of measurement of resistance values based on the above results.

As can be confirmed in FIGS. 10 and 11, the composite anodes including EVA (Examples 1 to 4) showed low resistance compared to the composite anode including NBR (Comparative Example 1) in all binder amounts. In particular, the composite anode including EVA60 of Example 3 had the lowest resistance.

### Test Example 5—Evaluation of Cycle Performance of all-Solid-State Battery Including Composite Anode

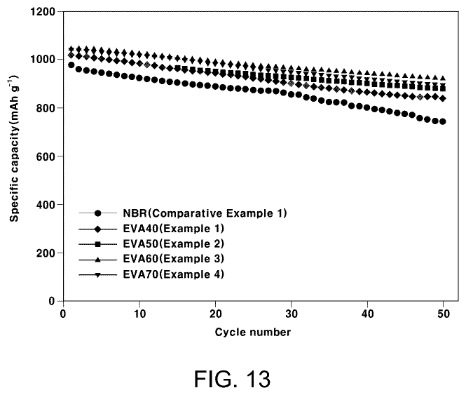

FIGS. 12 and 13 show results of discharge capacity depending on the cycle number obtained by charging and discharging an all-solid-state battery including the composite anode manufactured in each of Examples 1 to 4 and Comparative Example 1 at a current rate of 0.3 C. Here, the amount of the binder employed in the composite anode was 2.0 wt % or 1.0 wt %, and charging and discharging conditions were 30° C. and a current rate of 0.3 C.

As shown in FIG. 12, the composite anodes including 2.0 wt % of the binder exhibited initial discharge capacities of 1009 mAh/g, 1010 mAh/g, 1039 mAh/g, and 1014 mAh/g for EVA40, EVA50, EVA60, and EVA70, respectively, at a current rate of 0.3 C and showed capacity retentions of 81.1%, 84.3%, 85.9%, and 82.6%, respectively, at 50 cycles.

In addition, as shown in FIG. 13, the composite anodes including 1.0 wt % of the binder exhibited initial discharge capacities of 1020 mAh/g, 1013 mAh/g, 1047 mAh, and 1045 mAh/g for EVA40, EVA50, EVA60, and EVA70, respectively, at a current rate of 0.3 C and showed capacity retentions of 82.5%, 87.1%, 88.3%, and 85.9%, respectively, at 50 cycles.

As is apparent from FIGS. 12 and 13, the composite anodes of Examples 1 to 4 including EVA of the present disclosure exhibited better cycle characteristics than the composite anode including NBR of Comparative Example 1.

Therefore, it can be concluded that using EVA as a binder enables superior lifespan characteristics to be maintained even with a low amount of binder in the composite anode, due to its excellent adhesion and binding properties thereof. In particular, based on the above test results, the composite anode in Example 3, which included EVA60 and showed the highest adhesion and the lowest resistance value, exhibited the best cycle characteristics.

According to the present disclosure, since a composite anode layer includes an ethylene-vinyl acetate copolymer as a binder, high binding and adhesion properties can be exhibited even when the amount of the binder is relatively low.

In addition, according to the present disclosure, mechanical and electrical properties such as flexibility, adhesion, resistance, and the like of the composite anode layer can be improved by adjusting the amount of vinyl acetate in the ethylene-vinyl acetate copolymer.

The effects of the present disclosure are not limited to the above-mentioned effects. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A composite anode layer, comprising:
an anode active material;
a solid electrolyte having lithium ion conductivity; and
a binder capable of binding the anode active material and the solid electrolyte together,
wherein the binder comprises an ethylene-vinyl acetate copolymer.

2. The composite anode layer of claim 1 wherein the anode active layer is capable of intercalation and deintercalation of lithium ions.

3. The composite anode layer of claim 1, wherein the anode active material comprises any one selected from the group consisting of a graphite-based active material, a silicon-based active material, lithium titanium oxide, and combination thereof.

4. The composite anode layer of claim 3, wherein the graphite-based active material comprises any one selected from the group consisting of natural graphite, artificial graphite, and combination thereof.

5. The composite anode layer of claim 3, wherein the silicon-based active material comprises any one selected from the group consisting of silicon, silicon oxide, silicon carbide, a silicon alloy, and combination thereof.

6. The composite anode layer of claim 3, wherein the lithium titanium oxide comprises any one selected from the group consisting of Li₄Ti₅O₁₂, LiTi₂O₄, Li₂TiO₃, Li₂Ti₃O₇, and combination thereof.

7. The composite anode layer of claim 1, wherein the solid electrolyte comprises a sulfide-based or an oxide-based solid electrolyte.

8. The composite anode layer of claim 7, wherein the sulfide-based solid electrolyte comprises any one selected from the group consisting of Li₆PS₅X (X═Cl, Br, or I), Li₁₀GeP₂S₁₂, Li₃PS₄, Li₇P₃S₁₁, and combination thereof.

9. The composite anode layer of claim 1, wherein the binder is dispersed in the composite anode layer without forming a separate layer.

10. The composite anode layer of claim 1, wherein the ethylene-vinyl acetate copolymer is represented by Chemical Formula 1 below. 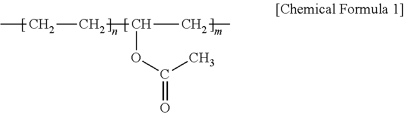
(in which n and m are integers of 1 or more)

11. The composite anode layer of claim 1, wherein the ethylene-vinyl acetate copolymer comprises about 10 wt % to 90 wt % of vinyl acetate.

12. The composite anode layer of claim 1, wherein the ethylene-vinyl acetate copolymer comprises about 40 wt % to 70 wt % of vinyl acetate.

13. The composite anode layer of claim 1, wherein the ethylene-vinyl acetate copolymer comprises about 55 wt % to 65 wt % of vinyl acetate.

14. The composite anode layer of claim 1, comprising, based on a total weight of the composite anode layer:
about 60 wt % to 90 wt % of the anode active material;
about 10 wt % to 45 wt % of the solid electrolyte; and
about 0.1 wt % to 5 wt % of the binder.

15. An all-solid-state battery, comprising:
an anode current collector;
the composite anode layer of claim 1 disposed on the anode current collector;
a solid electrolyte layer disposed on the composite anode layer and comprising a solid electrolyte;
a cathode layer disposed on the solid electrolyte layer and comprising a cathode active material; and
a cathode current collector disposed on the cathode layer.

16. The all-solid-state battery of claim 15, wherein the cathode active material comprises an oxide active material or a sulfide active material.

17. A method of manufacturing a composite anode, comprising:
preparing a composite anode slurry by mixing an anode active material, a solid electrolyte, and a binder with an organic solvent; and
forming a composite anode layer by applying the composite anode slurry onto an anode current collector and drying,
wherein the binder comprises an ethylene-vinyl acetate copolymer.

18. The method of claim 17, wherein the organic solvent comprises any one selected from the group consisting of N-butyl butyrate, benzyl acetate, 1,4-dichlorobutane, dichlorobenzene, and combination thereof.

19. The method of claim 17, wherein the ethylene-vinyl acetate copolymer comprises about 10 wt % to 90 wt % of vinyl acetate.

20. A vehicle comprising the all-solid-state-battery of claim 15.
